(19) United States
(12) Patent Application Publication
(10) Pub. No.: US 2010/0230861 A1
(43) Pub. Date: Sep. 16, 2010

(54) SYSTEMS AND METHODS FOR MAKING PRODUCTS FROM GRANULAR RUBBER

(75) Inventors: Edward R. Richardson, Calhoun, GA (US); Jeffrey Glenn Robertson, Calhoun, GA (US); Jeffrey A. Williams, Calhoun, GA (US); Tracy Cochran, Calhoun, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Mohawk Carpets, LLC

(21) Appl. No.: 12/402,222

(22) Filed: Mar. 11, 2009

(51) Int. Cl. B29C 43/04; B29C 43/32

(52) U.S. Cl. 264/331.13; 425/432; 425/424

(57) ABSTRACT

Various embodiments of the present invention provide systems and methods for manufacturing crumb rubber products. In various embodiments, the product being manufactured is a floor mat, which may be a decorative floor mat or fatigue floor mat used in industrial applications. In various embodiments, a crumb rubber and binder mixture is dispensed into a pan and leveled within the pan using a vibratory leveling operation. A die release may then be applied and the pan conveyed into a press. The press may be equipped with an upper die, which is compressed against the crumb rubber in the pan. The press applies both heat and pressure to activate the binder, which bonds the crumb rubber granules together to form a cohesive mat.

### FIELD OF THE INVENTION

Embodiments of the present invention are directed to systems and methods for making products using granular rubber.

### BACKGROUND

A common recycling technique for used tires is to reduce the rubber content to a granular consistency. This granular material is sometimes referred to as crumb rubber and can be used in a variety of applications. Common applications include foundation materials, acoustic barriers, speed bumps, insulation, adhesives, shoes, and playground surfacing.

The process for making crumb rubber from tires includes breaking down the tires using mechanical techniques such as grinding, cracker mills and granulators. Steel belts may be removed using magnetic separators or other separating techniques (e.g., shakers, centrifuge, air classification, etc.). In some cases, cryogenic techniques may be used to reduce the used tires to a granular state. Once the material has been reduced to a desired particle size, it may be combined with a binder and processed into other products. Crumb rubber is typically provided with a particular size distribution based on percentages of the material being captured by different screen sizes. For example, crumb rubber may be provided with a size distribution where 0-2% would be captured by an 8 mesh screen, 5-15% would be captured by a 10 mesh screen, 65-85% would be captured by a 25 mesh screen, 0-10% would be captured by a 30 mesh screen and only 5-15 would not be captured by the above screens.

In one common application, crumb rubber is combined with a binder and compression molded into a floor mat for residential or business use. This process typically involves shoveling a mixture of crumb rubber and a binder into a bucket of a particular size, which is then dumped into a pan that may include features that will create impressions in the top surface of the mat. The crumb rubber and binder mixture is then screeded to remove excess material. After screeding the crumb rubber mixture, the pan is loaded into a press which applies both pressure and heat to the crumb rubber mixture to activate the binder such that individual crumb rubber granules bond with neighboring granules to form a cohesive mat. After the press cycle, the mat may be removed from the mold and trimmed to size. In some cases, an adhesive may be applied to the upper surface of the mat followed by the application of a flock material. A colored design may then be applied to the flocked surface. For some mats, a colored glaze may be applied to the mat instead of the adhesive and flock material.

A problem that can arise in the production of crumb rubber mats is that the density of the mat is inconsistent as a result of poor leveling of the crumb rubber material in the pan. Low density areas can represent weak points in the mat. Another potential problem with known mat production processes is the introduction of contamination into the crumb rubber mixture. During the screeding process, material screeded from the pan falls to the floor and is periodically gathered and reused. In this recycling process, there is a potential for contamination to be gathered as well as excess crumb rubber, which could result in poor quality mats. Accordingly there is a need for improved systems and methods for manufacturing products using granular rubber.

### BRIEF SUMMARY OF THE INVENTION

Various embodiments of the present invention provide systems and methods for manufacturing crumb rubber products address problems in the industry, some of which are discussed above. In one embodiment, a system for forming a mat from crumb rubber is provided. This system includes a crumb rubber dispensing system configured to dispense a mixture of crumb rubber and a binder into a pan; a leveling system configured to selectively secure the pan and apply a vibration to the pan to disperse the crumb rubber and binder mixture in the pan; and a compression press having at least one platen with an upper die attached thereto, the upper die including a blade defining the boundary of the mat, wherein the compression press is configured to compress the crumb rubber within the pan using the upper die and wherein the blade is configured to engage the pan.

In another embodiment, a process for forming mats from crumb rubber is provided. The process includes the steps of: providing a mixture comprising crumb rubber and a binder; dispensing a predetermined amount of the crumb rubber and binder mixture into a pan; selectively securing the pan to a leveling device; applying a vibration to the pan using the leveling device to distribute the crumb rubber and binder mixture within the pan; and compressing the crumb rubber between an upper die and the pan to form a mat wherein the upper die includes a blade defining the boundary of the mat.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of a crumb rubber manufacturing system 10 in accordance with an embodiment of the present invention.

FIG. 2 is a schematic diagram of a portion of the manufacturing system 10 in accordance with an embodiment of the present invention.

FIG. 3 is a schematic diagram of a dispensing system 20 in accordance with an embodiment of the present invention.

FIG. 4 is a schematic diagram of a leveling system 40 in accordance with an embodiment of the present invention.

FIG. 5 is a schematic diagram of a mat forming system 60 in accordance with an embodiment of the present invention.

FIG. 6 is a schematic diagram of an upper die in accordance with an embodiment of the present invention.

FIG. 7 is a schematic diagram of a press 80 and a mat retrieval system 90 in accordance with an embodiment of the present invention.

FIG. 8 is a schematic diagram of a vacuum pickup assembly 120 in accordance with an embodiment of the present invention.

FIG. 9 is a cross section view of a vacuum pickup 130 in accordance with an embodiment of the present invention.

FIG. 10 is a top view of the vacuum pickup 130 shown in FIG. 9.

FIG. 11 is a schematic diagram of a pan cleaning system 140 in accordance with an embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Various embodiments of the present invention provide systems and methods for manufacturing crumb rubber products. In various embodiments, the product being manufactured is a floor mat, which may be a decorative floor mat or fatigue floor mat used in industrial applications. In various embodiments, a crumb rubber and binder mixture is dispensed into a pan and leveled within the pan using a vibratory leveling operation. A mold release may then be applied and the pan conveyed into a press. The press may be equipped with an upper die, which is compressed against the crumb rubber in the pan. The press applies both heat and pressure to activate the binder, which bonds the crumb rubber granules together to form a cohesive mat. After the press cycle, the pan may be conveyed out of the press, and the mat removed from the pan for further processing, if desired.

As noted above, used tires may be a source of crumb rubber. As used herein, however, “crumb rubber” should be interpreted as granular rubber from any source whether virgin material, recycled or a combination of both unless specified otherwise.

Manufacturing System 10

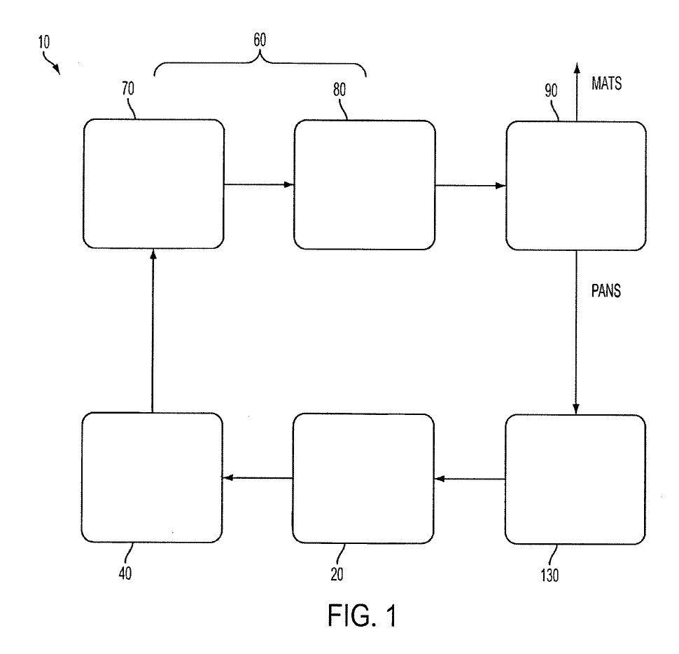

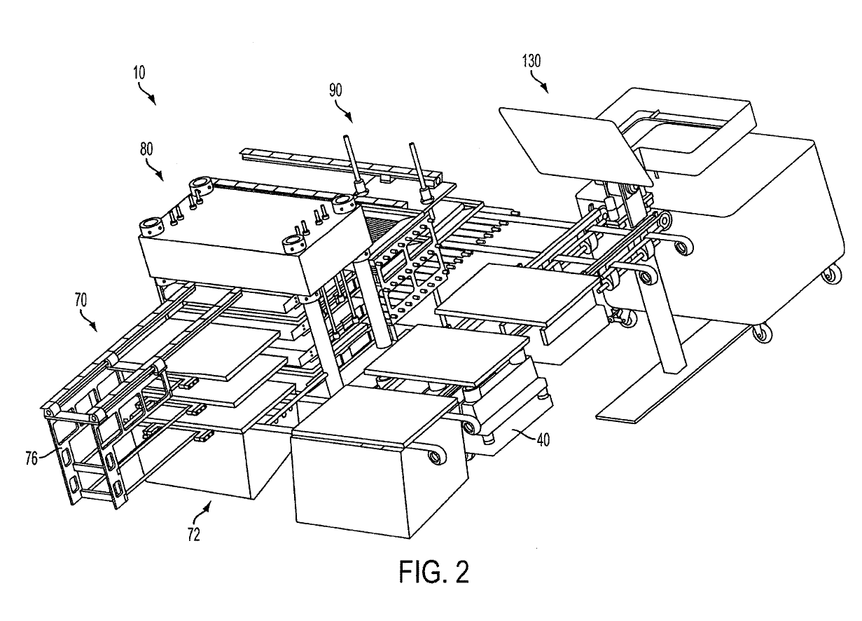

FIGS. 1 and 2 are diagrams of a manufacturing system 10 in accordance with various embodiments of the present invention. Although aspects of the present invention may be used in producing any product from crumb rubber, various aspects of the present invention will be described in connection with a process for making rubber mats, to facilitate understanding.

The manufacturing system 10 includes a dispensing system 20, a leveling system 40, a mat forming system 60, a retrieval system 90, and a pan cleaning system 130. The mat forming system may include an accumulator 70 and a press 80. In various embodiments, a pan receives a predetermined amount of a crumb rubber mixture from the dispensing system 20 and is conveyed to the leveling system 40 by a conveyor. The dispensed crumb rubber mixture is leveled in the pan, and the pan is conveyed to the accumulator 70. Once the accumulator 70 has accumulated a predetermined number of pans, the pans are transferred into the press 80. The press 80 applies heat and pressure to the crumb rubber mixture for a predetermined time to activate the binder such that a coherent mat is formed. Following the press cycle, the pan is removed from the press and the finished mat removed from the pan. The hot mat may then be conveyed for subsequent processing such as coating, flocking and printing as will be understood by those of skill in the art. The pan may be conveyed to the pan cleaning system to have excess crumb rubber removed and collected for potential reuse.

As noted above, conveyors may be used to transport the pans between systems. The conveyors may be any combination of known conveying systems such as belt conveyors, roller conveyors, or pick-and-place robots.

Dispensing System 20

FIG. 2 illustrates an embodiment of the dispensing system 20. The dispensing system 20 includes a mixing chamber 22, a conveying device 24 and a dispensing unit 30. The mixing chamber 22 receives a predetermined amount of crumb rubber and a predetermined amount of a binder from conventional storage systems and mixes these substances to form a crumb rubber mixture. As will be understood those of skill in the art, crumb rubber may be stored in a container, bin or silo and conveyed to the mixing chamber using an auger, conveyor belt, gravity feed or other known or developed feeding system. The amount of crumb rubber conveyed to the mixing chamber 22 from a conventional storage system for each batch may be controlled by weight. In some embodiments, the conventional storage system includes a feeder and a scale operatively connected thereto. The feeder may convey a predetermined amount of crumb rubber based on data received from the operatively connected scale. In other embodiments, the amount of crumb rubber delivered may be determined using other techniques such as flow meters.

Similarly, the predetermined amount of binder per batch delivered to the mixing chamber may be determined base on weight, flow rate or other metering technique. In various embodiments, the mixture comprises approximately 95% crumb rubber and 5% binder based on weight. Other embodiments may include different ratios of rubber and binder, and may further include other substances such as other granular or chemical additives.

The mixing chamber 22 receives the predetermined amount of crumb rubber and binder from conventional storage systems and combines the two substances to form a crumb rubber and binder mixture. In various embodiments, the predetermined amounts are relatively small such that the mixing chamber 22 is mixing material almost continuously. For example, the predetermined batch size may represent enough material for a limited number of mats (e.g., 15 mats) or for a limited amount of time (e.g., 10 minutes) based on cycle times for the manufacturing process. In some embodiments, small batches are used to reduce the possibility that the binder may start to cure before the mixture is dispensed into a pan. It should be understood, however, that some embodiments may use larger or smaller batches than the forgoing examples. In some embodiments, the mixing chamber 22 may mix a new batch for each mat.

The conveying device 24 transfers a predetermined amount of the crumb rubber mixture into the dispensing unit 30. The conveying device 24 may be an auger or other known device for conveying granular material. In various embodiments, the predetermined amount is the amount of crumb rubber mixture necessary for a single pan which would be enough for a single mat plus a waste factor. This may be controlled based on feedback from a scale (not shown) operatively connected to the dispensing unit 30. In other embodiments, the conveyed amount may be controlled based on weight as determined by a scale or a flow meter operatively connected to the conveying device 24, by the height of material in the dispensing unit 30, or other metering technique.

The dispensing unit 30 is configured to receive the predetermined amount of the crumb rubber mixture and dispense it into a pan 12. The pan 12 is substantially planar with upstanding flanges 15 proximate the periphery of the pan. In some embodiments, the pan 12 may be textured or have some contour as desired. The planar surface area of the pan 12 is marginally larger than the mat to be produced. For example, the pan may be an inch longer and wider than the mat to be produced. In the illustrated embodiment, the flanges 15 are substantially perpendicular to the planar surface of the pan; however, the flanges 15 in other embodiments may be flared inwardly or outwardly as desired. In various embodiments, the pans 12 may be constructed of steel, aluminum or other durable material. In various embodiments, the pans may have a non-stick coating applied to the inner surface to limit adhesion of the crumb rubber mixture to the pan 12 during processing. This coating may be a semi-permanent coating such as Teflon™ may be a release agent sprayed on the pan before the crumb rubber mixture is dispensed into the pan.

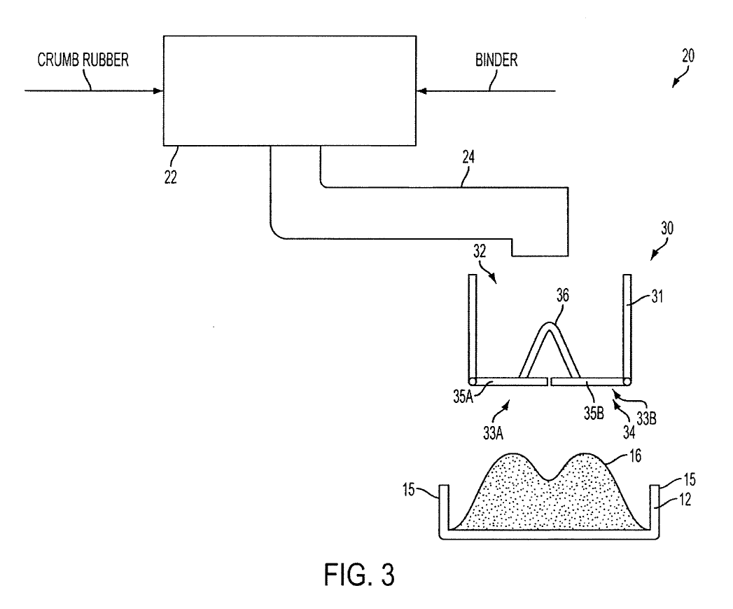

FIG. 3 illustrates a cross-section of a dispensing unit 30 and the pan 12 with a predetermined amount of the crumb rubber mixture 16 disposed therein. In the illustrated embodiment, the dispensing unit 30 includes a container 31 defining an interior volume with an inlet 32 and two outlets 33A-B. The inlet 32 is in communication with conveying device 24 and receives the crumb rubber mixture therefrom. The outlets 33A-B of the container 31 are disposed above the pan 12 and direct the crumb rubber mixture into the pan 12. In the illustrated embodiment, the container 31 has a substantially rectangular cross section; however, it should be understood, that other embodiments may use one or more containers. Moreover, the one or more containers may have any desired shape in cross-section such as circular, triangular or other regular or irregular shape.

The container 31 includes a valve member 34 operatively connected to the container 31 proximate the outlets 33A-B to selectively open and thereby allow the crumb rubber mixture held within the container 31 to be gravity fed through the outlets 33A-B into the pan 12. In the illustrated embodiment, the valve member 34 includes two doors 35A-B pivotably attached to opposing walls of the container 31 proximate the respective outlets 33A-B. In some embodiments, the edges of doors 35A-B opposite the pivoting attachment may engage to form a seal. Actuators may be operatively connected to the doors to selectively open the two doors thereby allowing the crumb rubber mixture to be dispensed. The speed with which the doors open may be controlled to achieve a desired distribution of the crumb rubber mixture in the pan 12. In other embodiments, the doors may open and close through some type of biasing device such as a spring or other mechanism. Furthermore, the doors may open simultaneously, or they may open in sequence.

In the illustrated embodiment, the container 31 includes an interior divider 36 which creates two chambers of substantially the same size within the container 31 with each chamber in communication with a respective outlet 33A-B. The divider 36, in the illustrated embodiment, is narrower proximate the inlet 32 and widens proximate the outlets 33A-B. When the crumb rubber mixture is released from the two chambers by the valve member 34, a pile of the crumb rubber mixture having two distinct peaks (i.e. bimodal) may be created in the pan 12 as illustrated. In other embodiments, other types of dividers may be employed to create other multi-modal or other desired distributions. The other types of dividers may have different shapes such as a pyramid or a cone shapes to affect different distributions of the crumb rubber mixture in the pan. In further embodiments, multiple dispensing units may be used for directing a crumb rubber mixture into a single pan to obtain a bimodal distribution or other desired distribution of the crumb rubber mixture. In still further embodiments, no divider may be present in the container.

Leveling System 40

After the crumb rubber mixture is dispensed into the pan, the pan is conveyed to the leveling system 40. In one embodiment, the leveling system 40 uses vibration to distribute the crumb rubber mixture evenly within the pan. As used herein, “distributed evenly” means the thickness of the crumb rubber pile within the pan varies within industrial norms and does not mean perfectly distributed or perfectly level. For example, an acceptable thickness deviation could be within a range of 0.25 inches.

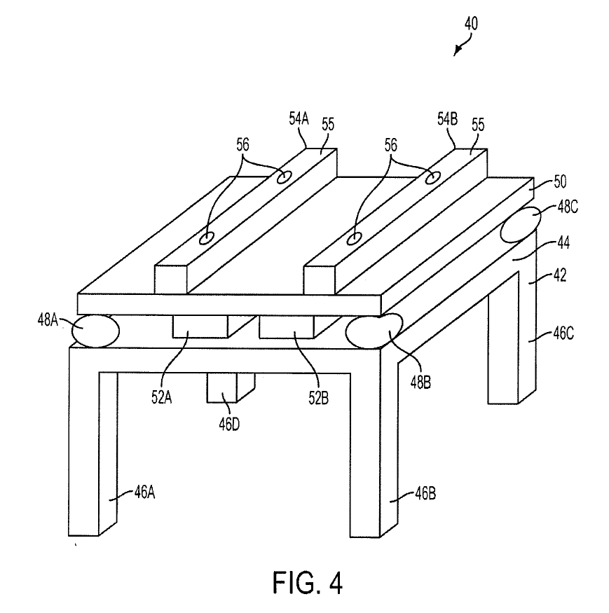

FIG. 4 illustrates an embodiment of the leveling system 40. The leveling system 40 includes a frame 42, four inflatable supports 48A-D (48D not shown), a vibration platform 50, two vibration units 52A, B, two support rails 54 A-B, and four magnets 56. The frame 42 is a substantially rigid structure having a base portion 44 and four legs 46A-D.

The four inflatable supports 48A-D (48D not shown) are disposed between the base portion 44 and the vibration platform 50 such that the weight of the vibration platform 50 is supported substantially by the base portion 44 via the inflatable supports 48A-D. The vibration platform 50 is a substantially planar structure constructed of steel, aluminum or other rigid material. The inflatable supports 48A-D are attached to both the base portion 44 and the vibration platform 50. In some embodiments, more or less inflatable supports may be disposed between the base 44 and the vibration platform 50.

In various embodiments, the degree of inflation of each inflatable support 48A-D is independently adjustable and can affect the vibration of the platform 50 proximate the particular inflatable support. In one embodiment, the inflatable supports 48A-D are adjusted such that the platform is substantially level; however, in other embodiments, the inflatable supports may be adjusted to tilt the table. In some embodiments, the vibration platform 50 may be tilted from one orientation to another in a particular sequence during a vibration cycle to achieve a desired distribution of the crumb rubber mixture. For example, the vibration platform 50 may be tilted to one side and then the opposite side while the vibration platform 50 is vibrated to facilitate better distribution of the crumb rubber mixture. In use, the vibration amplitude of the vibration platform 50 may be tuned by selectively adjusting the inflation of the inflatable supports 48A-D. The more the inflatable supports 48A-D are inflated, the smaller the amplitude of the vibration platform 50 during vibration. In some embodiment, the inflatable supports are tuned such that the amplitude of the vibration is approximately 10 times the average diameter of the crumb rubber granules. In some embodiments, the amplitude may be approximately 2 to 2.5 inches. In further embodiments, the amplitude is varied during a vibration cycle by varying the degree of inflation of the inflatable supports 48A-D.

Mounted on the bottom surface of the vibration platform 50 are two vibration units 52A-B. As will be understood by those skilled in the art, the vibration units 52A-B introduce a vibration into the vibration platform 50. In various embodiments, the two vibration units 52A-B are synchronized such that they vibrate in phase with substantially the same frequency. In some embodiments, one or more vibration unit(s) may be used. In some embodiments the amplitude and/or the frequency of vibration produced by the vibration unit(s) may be varied to achieve a desired vibration of the vibration platform 50. In some embodiments, this may be varied during a vibration cycle.

Support rails 54A-B are attached to the upper surface of the vibration platform 50 and are configured to support the pan 12 (no shown). In the illustrated embodiment, the support rails 54A-B are elongate structures securely fastened to the vibration platform 50 such that the longitudinal axes of the support rails 54A-B are substantially parallel with the planar surface of the vibration platform 50. The two support rails 54A-B are also substantially parallel to each other in the illustrated embodiment, but in other embodiments they may not be parallel. The support rails 54A-B provide a support surface 55 for the pan that is substantially parallel with vibration platform 50. In the illustrated embodiment, electromagnets 56 are disposed proximate the support surface 55 of the support rails 54A-B. These electromagnets 56 may be selectively activated to engage a pan disposed on the support rails 54A-B to facilitate transfer of the vibration introduced into the vibration platform 50 by the vibration units 52A-B into the pan. After the vibration cycle, the electromagnets may be deactivated to allow the pan to be transferred to the next station. In other embodiments, mechanical devices may be employed to selectively secure the pan to the support rails 54A-B. In some embodiments, the leveling system 40 may not include support rails and the pans may be engaged by the vibration platform 50 directly. In these embodiments, the vibration platform 50 may include magnetic or mechanical devices to secure the pan to the vibration platform 50.

Mat Forming System 60

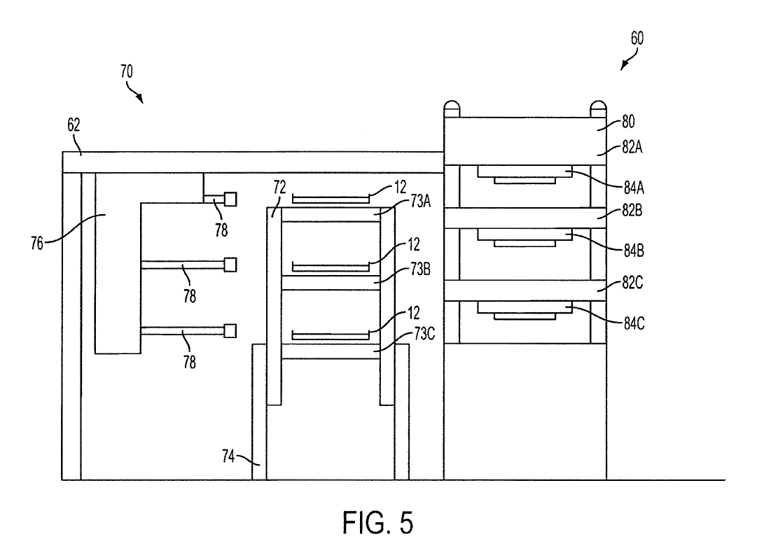

After the leveling cycle is complete, a mold release agent may be sprayed onto the crumb rubber mixture as it is conveyed to the mat forming system 60. FIG. 5 illustrates an embodiment of the mat forming system 60. The mat forming system 60 includes a frame 62, an accumulator 70, and a press 80.

The accumulator 70 is configured to receive and temporarily store a predetermined number of pans and to transfer the stored pans into the press 80. In the illustrated embodiment, the accumulator 70 gathers three pans 12 and transfers the three pans 12 into a multi-daylight press 80 having three platens 82A-C. The accumulator 70 includes a multi-pan magazine 72 and a transfer device 76. The accumulator 70 receives pans from the leveling system 40 via a conveyor (not shown).

The multi-pan magazine 72 includes a series of shelves 73A-C vertically aligned where each shelf is sized to receive a pan 12. The multi-pan magazine 72 is slideably attached relative to a base structure 74 to permit vertical movement of the multi-pan magazine 72 such that the individual shelves can be sequentially aligned with a conveyor (not shown) transferring pans from the leveling system 40. Each shelf 73A-C may include a sensor to detect the presence of a pan 12. For example, the multi-pan magazine 72 may move vertically to align the top shelf 73A with the conveyor and remain there until a pan 12 is conveyed onto the shelf. Once a pan is detected by a presence sensor, the multi-pan magazine 72 may move upwardly to align the next shelf 73B with the conveyor. This process may continue until each shelf of the multi-pan magazine holds a pan 12.

After the multi-pan magazine 72 is full, the pans 12 may be conveyed into the press 80 by the transfer device 76. As will be understood by those of skill in the art, the shelves 73A-C in the multi-pan magazine 72 may be positioned into substantial alignment with the multiple openings in the press 80. The transfer device 76 is slideably attached relative to the frame 62 and includes a plurality of cantilevered bars 78 configured to engage the pans 12 held by the multi-pan magazine 72. In the illustrated embodiment, the multi-pan magazine 72 includes three shelves and the transfer device 76 includes three cantilevered bars 78. Although the bars may be of differing lengths as illustrated in FIG. 5, the bars engage the pans 12 at substantially the same time and push the pans into the press 80. In other embodiments, the bars may be of substantially the same length. As will be understood by those of skill in the art, the multi-pan magazine itself may include a transferring device for conveying the pans into the press, such as selectively activated rollers, as opposed to an independent transferring device 76.

In the illustrated embodiment, the press 80 is a multi-daylight press with three moveable platens 82A-C that is configured to apply both heat and pressure to the crumb rubber mixture in the pans 12. The press 80 may be pneumatic, hydraulic or other known type of press that has the capability to apply both heat and pressure. In various embodiments, the press 80 may be a single daylight press or a multi-daylight press having any number of platens. After the pans 12 are received into the press 80, the press 80 closes such that the upper dies 84A-C compress the crumb rubber mixture within the pan. The press 80 applies both heat and pressure to the crumb rubber mixture within the pans to form three mats.

In the illustrated embodiment, the upper dies 84A-C form the decorative upper surface of a mat, and the pan forms the bottom substantially planar surface of the mat. In this way, the same pans can be used with different upper dies to produce different styles of mats at the same time. In other embodiments, the pans may be configured to form the upper surface of the mat and the upper die carried by the moveable platens form the bottom of the mat.

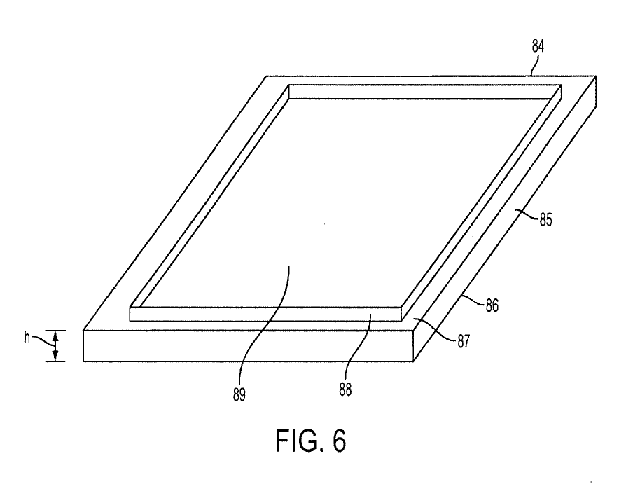

FIG. 6 illustrates an upper die 84 turned upside down to show the features of an upper die 84. The upper die 84 includes a base 85, a blade 88 and a compression area 89. The base 85 is a planar member having a mounting surface 86 and a forming surface 87. The mounting surface 86 is selectively attached to a platen 82 in the press 80. The forming surface 87 includes a blade 88 and a compression area 89. The blade 88 defines the final boundary of the mat to be produced. In the illustrated embodiment, the blade 88 is rectangular, but in other embodiments, it may be any regular (e.g., square, triangular, hexagonal) or irregular shape. In various embodiments, as the press 80 closes and the upper die 84 engages the crumb rubber mixture held by the pan, the blade 88 cuts through the crumb rubber mixture and engages the pan. As a result, a mat is formed to size during the compression operation. A benefit of these embodiments is that the customary die cutting of the mat to size after the compression operation may not be necessary.

The compression area 89 comprises the area within the blade and may include decorative features which are imparted into the mat surface. The blade 88 is designed to fit within the upstanding flanges of the pan. In some embodiments, a clearance of approximately 0.5 inches may be maintained between the flanges of the pan and the blade 88 when the upper die 84 engages the crumb rubber mixture in the pan.

In the various embodiments, the upper die 84 may be configured to only compress the crumb rubber mixture within the blade 88. Because the crumb rubber outside the blade is not subject to both pressure and heat, the binder may not cure. As a result, this uncured material may be reused. This may be accomplished by designing the upper die such that the base height “h” within the blade is greater than the base height outside the blade. In other embodiments, however, the base height outside and inside the blade may be the same such that substantially all of the crumb rubber within the pan is compressed.

The height of the blade 88 and the base height within the compression area 89 are sized to achieve a predetermined compression of the crumb rubber during the forming process. In operation, the press 80 compresses the crumb rubber mixture between the upper die 84 and the pan 12, until the blade contacts the pan's upper surface. In other embodiments, the blade does not contact the pan and leaves flashing proximate the mat boundary. In some embodiments, the travel of the press is controlled to a predetermined distance, while other embodiments are controlled to a predetermined pressure.

Retrieval System 90

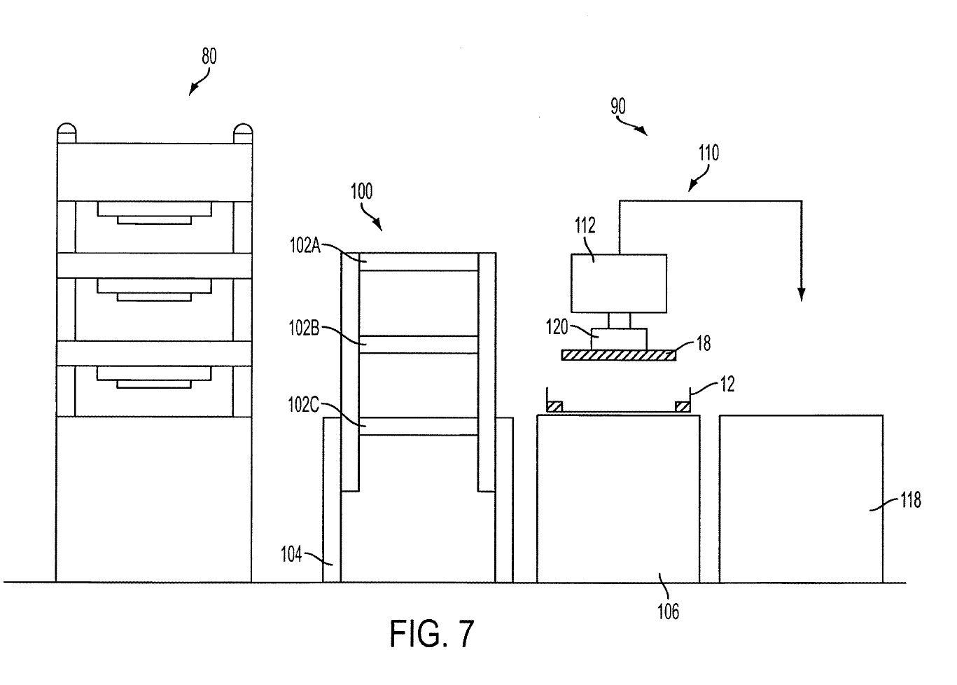

FIG. 7 illustrates an embodiment of a mat retrieval system 90 that is configured to receive the pans from the press and remove the formed mats from the pans. The retrieval system 90 includes a magazine 100, and a mat transfer device 110.

The magazine 100 includes a series of shelves 102A-C vertically aligned where each shelf is sized to receive a pan 12. The multi-pan magazine 72 is slideably attached relative to a base structure 104 to permit vertical movement of the magazine 100 such that the individual shelves can be sequentially aligned with a conveyor 106 to convey a pan thereto. In one embodiment, each shelf includes a plurality of rollers with one or more of the rollers per shelf being powered. As will be understood by those skilled in the art, the powered rollers may be selectively activated to convey a particular pan out of the magazine and onto the conveyor 106.

After a pan has been conveyed onto the pan conveyor 106, a mat retrieval device 110 engages the mat 18 within the pan and places it on a mat conveyor 118. The mat retrieval device 110 may be a pick and place robot 112 equipped with a vacuum pickup assembly 120 that uses vacuum pressure to engage the mat and retrieve it from the pan. Because the mats are porous, there may be a tendency for the vacuum pickup assembly to not only engage the mat but also to engage the pan holding the mat. Thus, the air volume and air velocity provided to the vacuum pickup assembly 120 may need to be tuned to “pick” the mats from the pan.

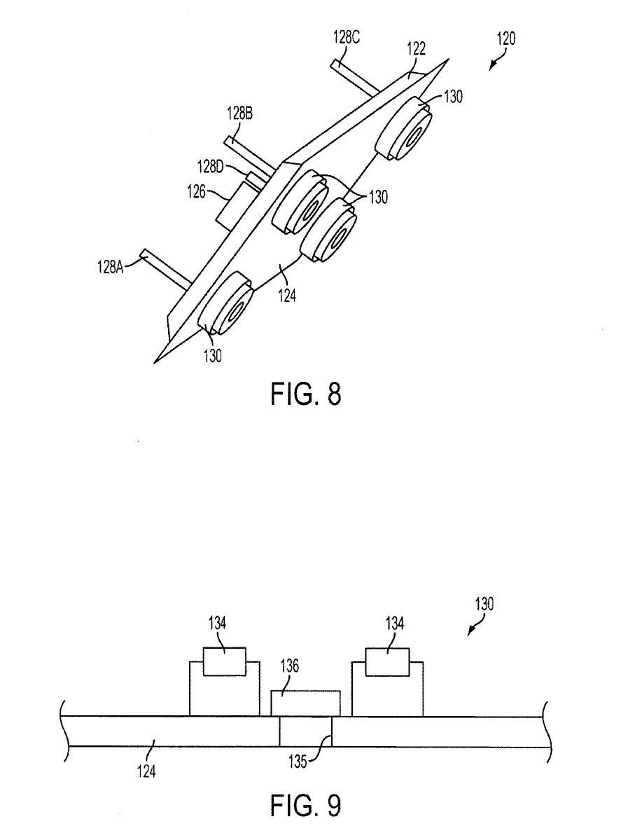

FIG. 8 illustrates an embodiment of the vacuum pickup assembly 120 that may be used in conjunction with embodiments of the present invention. The vacuum pickup assembly 120 includes a vacuum box 122, a cover 124, a vacuum conduit 126, four attachment bars 128A-D, and four vacuum pickups 130.

The vacuum box 122 and the cover 124 are attached to define a vacuum cavity therebetween. The interface between the vacuum box 122 and the cover 124 may be substantially sealed to facilitate drawing of a vacuum. The vacuum conduit 126 is attached to the vacuum box 122 and provides a fluid communication path between the vacuum cavity and a vacuum source (not shown) such as a vacuum pump. The vacuum conduit 126 may comprise a hose with mating quick connect nozzles or other mechanisms for providing communication between the vacuum source and the vacuum cavity formed by the vacuum box 122 and the cover 124.

Also attached to the vacuum box 122 are four attachment bars 128A-D. These bars facilitate attachment of the vacuum pickup assembly 120 to the robot 112.

In the illustrated embodiment, four vacuum pickups 130 are attached to the cover 124. The vacuum pickups are positioned proximate holes formed in the cover 124 and provide a channel, which is in fluid communication with the vacuum cavity formed by the vacuum box 122 and the cover 124. The vacuum pickups are configured to engage the mats and the channel directs the vacuum pressure from the cavity formed by the vacuum box 122 and the cover 124 to the mats such that the mats are held against the vacuum pickups. The air velocity and air volume provided by the vacuum source may be tuned such that the vacuum engagement of the mat by the four vacuum pickups is sufficient to support the weight of the mat without picking up the pan beneath the mat. Although the illustrated embodiment includes four vacuum pickups, other embodiments may have more or less vacuum pickups as desired. Additionally, the illustrated embodiment shows the vacuum pickups with a circular cross-section, but other embodiments may have vacuum pickups with different shaped cross-sections such as rectangular, triangular, oval or other desired shape.

FIG. 9 illustrates a cross-section of a vacuum pickup 130 in accordance with an embodiment of the present invention. The vacuum pickup 130 includes an annular base 132, an annular seal 134 and a pad 136. The annular base 132 is attached to the cover 124 at one end and is substantially centered over an aperture 135 defined by the cover 124 which provides fluid communication to the cavity formed between the vacuum box 122 and the cover 124. The opposite end of the annular base 132 defines a cavity sized to receive the annular seal 134. In the illustrated embodiment, the annular seal 134 has a rectangular cross-section. In other embodiments, the annular seal 134 may have a different cross-section. The seal 134 is configured to engage a mat and to facilitate the drawing of a vacuum. It should be understood that the engagement between the annular seal 134 and the mat does have to be air tight to draw a vacuum gradient. In various embodiments, the annular seal 134 is formed from an elastomer material such as rubber. In some embodiments, the annular seal 134 is a silicone closed cell foam rubber. In some embodiments, an annular seal may not be used and instead the base engages the mat directly.

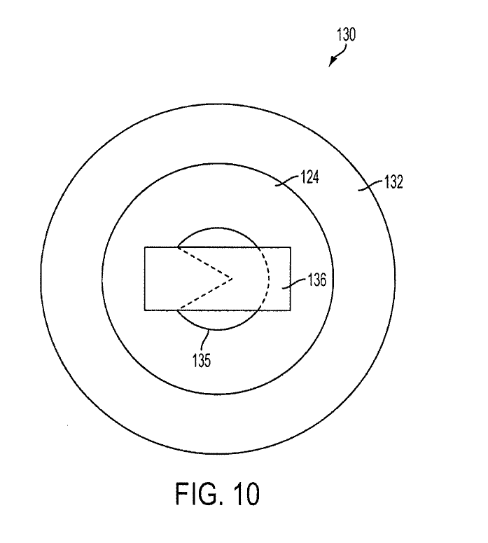

In the illustrated embodiment, the pad 136 is positioned within the annular ring of base 132. The pad may be substantially planar and constructed of an elastomer material. In one embodiment, the pad 136 is formed from a silicone closed cell foam rubber. In various embodiments, the pad 136 is positioned proximate the aperture formed in the cover 124 and may partially cover the aperture. The pat discourages the mat from being drawn into the aperture when the vacuum is applied. FIG. 10 illustrates a top view of the vacuum pickup 130 without the seal. In various embodiments, the aperture defined in the cover 124 has the shape of a circle with a triangular portion removed. The triangular shape may help support the pad positioned thereon from being drawn into the aperture by the vacuum. In other embodiments, the aperture may take other shapes such as square, rectangle, round or some irregular shape. In further embodiments, there may be multiple apertures such as two round apertures—one on each sided of the pad. Various other embodiments may not include a pad.

Once the robot 112 engages a mat 18 using the vacuum pickup assembly 120 held within the pan 12 and it transfers the mat 18 to a mat conveyor 118. The mat conveyor 118 may be any style of conveyor. In some embodiments, the mat conveyor 118 is a roller conveyor and the formed mats are queued until their temperature reaches a threshold and are then transferred to other secondary operations such as applying adhesive and a flocking material and/or other decorative coatings.

Pan Cleaning System 140

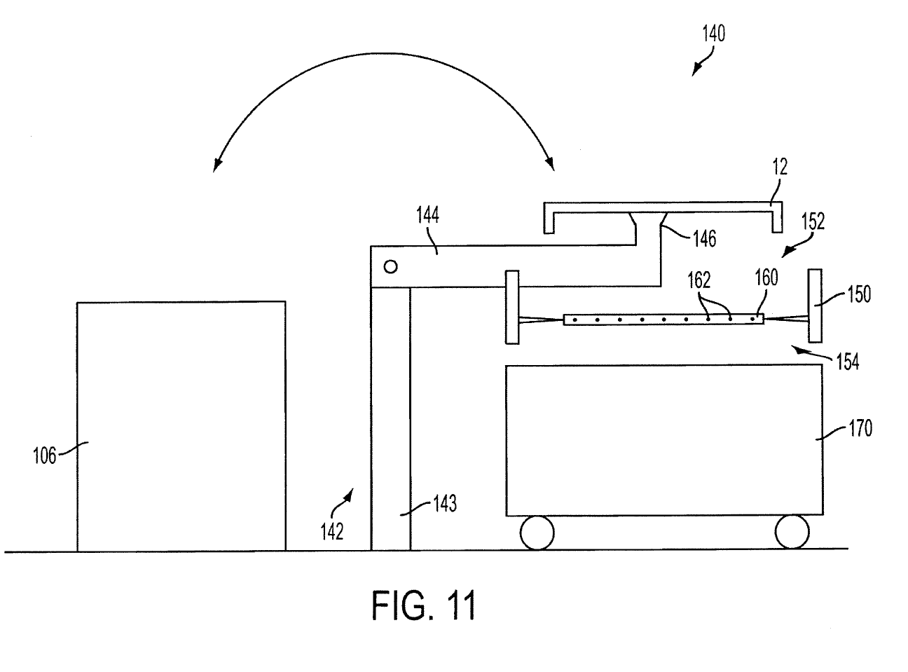

Once the mat has been removed from the pan 12, the pan 12 may be conveyed by conveyor 106 to a pan cleaning system 140 before being reused. FIG. 11 illustrates an embodiment of a plan cleaning system 140 that may be used in connection with the present invention. The pan cleaning system 140 includes a robot 142, a containment channel 150, and a collection bin 170. The robot 142 is configured to engage the pan 12 positioned atop the conveyor 106 and position the pan 12 in an inverted orientation proximate the containment channel 150. The robot 142 includes a base structure 143 and a transfer arm 144 pivotably connected to the base structure 143. The transfer arm 144 includes a pan interface portion 146 that may use vacuum pressure and suction cups to selectively engage the pan 12.

The containment channel 150, shown in cross-section in FIG. 11, includes an inlet 152 and an outlet 154. The containment channel 150 is configured to receive the excess crumb rubber mixture from the pan 12 through the inlet 152 and direct the excess crumb rubber to the outlet 154 and into the collection bin 170 positioned beneath the outlet 154. In the illustrated embodiment, the containment channel 150 includes an air nozzle 160 attached intermediate the inlet 152 and the outlet 154. This air nozzle is configured to direct a blast of air at the pan 12 to encourage release of the excess crumb rubber mixture from the pan 12. In various embodiments, the air nozzle 160 may comprise a tube bent into a substantially rectangular shape with a plurality of apertures 162 formed therein. The apertures 162 are positioned to direct air at a pan 12. After the pan has been cleaned, the robot 142 returns the pan to the conveyor 106 and it may be conveyed to the dispensing system to repeat the process.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for forming a mat from crumb rubber comprising:
a crumb rubber dispensing system configured to dispense a mixture of crumb rubber and a binder into a pan;
a leveling system configured to selectively secure the pan and apply a vibration to the pan to disperse the crumb rubber and binder mixture in the pan; and
a compression press having at least one platen with an upper die attached thereto, the upper die including a blade defining the boundary of the mat, wherein the compression press is configured to compress the crumb rubber within the pan using the upper die and wherein the blade is configured to engage the pan.

2. The system for forming a mat of claim 1, wherein the crumb rubber dispensing system includes a metering apparatus configured to determine a predetermined amount of the mixture to be dispensed based on weight.

3. The system for forming a mat of claim 1, wherein the crumb rubber dispensing system includes a dispensing unit with multiple outlets for dispensing the crumb rubber and binder mixture into the pan.

4. The system for forming a mat of claim 3, wherein the dispensing unit includes a container with a divider positioned therein which defines two outlets within the container.

5. The system for forming a mat of claim 1, wherein the leveling system further comprises a plural of magnets configured to selectively engage the pan to facilitate vibration of the pan.

6. The system for forming a mat of claim 1, wherein the leveling system includes a platform supported by a plurality of inflatable supports.

7. The system for forming a mat of claim 6, wherein the degree of inflation of the inflatable supports are individually adjustable.

8. The system for forming a mat of claim 1 further comprising a mat removal system configured to use vacuum pressure to remove the mat from the pan.

9. The system for forming a mat of claim 8 wherein the mat removal system includes:
a vacuum source; and
at least one vacuum pickup defining a channel in fluid communication with the vacuum source and configured to contact the mat and facilitate a vacuum engagement of the mat.

10. The system for forming a mat of claim 9, wherein the vacuum pickup includes a pad positioned within the annular ring.

11. The system of forming a mat of claim 1, wherein the pan includes a coating configured to discourage adhesion of the crumb rubber and binder mixture to the pan.

12. The system of forming a mat of claim 11, wherein the coating is a mold release agent applied to the pan.

13. The system of forming a mat of claim 1 further comprising a pan cleaning system having a robot configured to invert the pan and an air nozzle defining a plurality of nozzles configured to apply a burst of air to the inverted pan to encourage release of contaminate in the pan.

14. A process for forming mats from crumb rubber comprising the steps of:
providing a mixture comprising crumb rubber and a binder;
dispensing a crumb rubber and binder mixture into a pan;
selectively securing the pan to a leveling device;
applying a vibration to the pan using the leveling device to distribute the crumb rubber and binder mixture within the pan; and
compressing the crumb rubber between an upper die and the pan to form a mat wherein the upper die includes a blade defining the boundary of the mat and the blade engages the pan.

15. The process of claim 14, wherein the step of dispensing comprises forming a multimodal distribution of the crumb rubber and binder mixture in the pan.

16. The process of claim 14, wherein the provided mixture comprises approximately 95% crumb rubber and 5% binder.

17. The process of claim 14, wherein the selectively securing of the pan to the leveling device comprises selectively activating an electromagnet.

18. The process of claim 14, wherein the step of applying a vibration to distribute the crumb rubber and binder mixture comprises applying a vibration until the crumb rubber and binder mixture has a thickness variation of 0.5 inches or less.

19. The process of claim 14 further comprising the step of removing the mat from the pan using vacuum pressure.

20. The process of claim 14 further comprising the steps of:
accumulating a plurality of pans; and
inserting the plurality of pans into a multi-daylight press.

21. The process of claim 14, wherein the vibration has an amplitude and the amplitude changes during a vibration cycle.

22. The process of claim 14, wherein the pan is tilted from one orientation to a second orientation while the leveling device is applying a vibration.
